(19) United States
(12) Patent Application Publication
(10) Pub. No.: US 2026/0209524 A1
(43) Pub. Date: Jul. 23, 2026

(54) TWO-COMPONENT AQUEOUS EPOXY RESIN PAINT AND ARTICLE PREPARED THEREFROM

(71) Applicant: GUANGDONG HUARUN PAINTS CO., LTD., Foshan, Guangdong (CN)

(72) Inventor: Libin WU, Foshan, Guangdong (CN)

(21) Appl. No.: 19/137,928

(22) PCT Filed: Dec. 18, 2023
(86) PCT No.: PCT/CN2023/139533

§ 371 Date: Jun. 11, 2025

(30) Foreign Application Priority Data
Dec. 19, 2022 (CN) 202211634053.X

(51) Int. Cl. C09D 5/02; C09D 7/45; C09D 7/65; C09D 163/00

(52) U.S. Cl. CPC C09D 5/027; C09D 5/022; C09D 7/45; C09D 7/65; C09D 163/00

(57) ABSTRACT

A two-component aqueous epoxy resin paint is provided, including: a) a film-forming resin composition, the film-forming resin composition including at least one aqueous epoxy resin emulsion, deionized water, and additional additives; and b) an aqueous curing system comprising an epoxy-reactive curing agent; wherein the at least one aqueous epoxy resin emulsion includes at least one epoxy resin, at least one nonionic reactive epoxy resin emulsifier and deionized water, and wherein the two-component aqueous epoxy resin paint includes at least one hydroxyl compound, the at least one hydroxyl compound including at least one C1-C6 monohydric alcohol, at least one monoalkyl ether of C2-C3 dihydric alcohol, or a combination thereof. An article including a substrate having at least one major surface is also provided. A coating applied directly or indirectly to at least part of the major surface of the substrate, wherein the coating is formed by the two-component aqueous epoxy resin paint according to the present application.

### TECHNICAL FIELD

The present application relates to a two-component aqueous epoxy resin paint, and more specifically to a two-component aqueous epoxy resin paint having a pot life of 24 hours or longer.

### BACKGROUND

Epoxy resin has a wide range of application in coating industry. It is well known that an epoxy resin-curing system (also known as two-component epoxy resin paint) after curing can obtain a coating having good adhesion to substrates, especially metals, and having high mechanical strength, good chemical resistance and corrosion resistance. Therefore, an epoxy resin paint is considered to be one of the most cost-effective coating compositions in practice.

In the application of a two-component coating composition, its pot life determines the application period of the two-component coating composition. At present, conventional two-component aqueous epoxy resin paints on the market have a pot life of generally 2-4 h, which requires application to be complete within a very limited time period after the paint is formulated, to avoid difficult application or performance degradation at a later stage. In addition, this limited application window requires two-component aqueous epoxy resin paint to be made in small batches, and the paint must be formulated many times during the entire application process, which inevitably leads to differences in each batch, and is unfavorable for maintaining consistent coating performance.

In view of the above, there is a need in the coating industry for a two-component aqueous epoxy resin paint with extended pot life and optimal performance.

### SUMMARY

The present application in one aspect provides a two-component aqueous epoxy resin paint comprising: a) a film-forming resin composition, the film-forming resin composition comprising at least one aqueous epoxy resin emulsion, deionized water, and additional additives; and b) an aqueous curing system comprising an epoxy-reactive curing agent; wherein the at least one aqueous epoxy resin emulsion comprises at least one epoxy resin, at least one nonionic reactive epoxy resin emulsifier and deionized water, and wherein the two-component aqueous epoxy resin paint comprises at least one hydroxyl compound, the at least one hydroxyl compound comprising at least one C1-C6 monohydric alcohol, at least one monoalkyl ether of C2-C3 dihydric alcohol, or a combination thereof. It is preferred that the at least one hydroxyl compound comprises at least one C2-C4 monohydric alcohol, at least one C1-C4 monoalkyl ether of C2-C3 dihydric alcohol, or a combination thereof, preferably ethanol, n-propanol, isopropanol, ethylene glycol monomethyl ether, ethylene glycol monopropyl ether, ethylene glycol monobutyl ether, propylene glycol monomethyl ether, propylene glycol monoethyl ether, propylene glycol monopropyl ether, propylene glycol monobutyl ether, or a combination thereof.

In some embodiments of the present application, the film-forming resin composition is mixed with the aqueous curing system, and the resulting mixture exhibits a pot life of 24 hours or longer at 25° C.

According to another aspect of the present application there is provided an article, comprising a substrate having at least one major surface; and a coating applied directly or indirectly to at least part of the major surface of the substrate, wherein the coating is formed by the two-component aqueous epoxy resin paint of the present application. Preferably, the substrate is selected from metal, wood, wood composite, paper, plastic, fabric, ceramic, cementitious material or any combination thereof.

According to yet another aspect of the present application there is provided use of at least one hydroxyl compound for extending pot life of a two-component aqueous epoxy resin paint, wherein the at least one hydroxyl compound comprises at least one C1-C6 monohydric alcohol, at least one monoalkyl ether of C2-C3 dihydric alcohol, or a combination thereof and the two-component aqueous epoxy resin paint comprises at least one epoxy resin and at least one nonionic reactive epoxy resin emulsifier.

It was surprisingly discovered by the inventors of the present application that in the formulation of a two-component aqueous epoxy resin paint, adding specific hydroxyl compounds, for example at least one C1-C6 monohydric alcohol and/or at least one monoalkyl ether of C2-C3 dihydric alcohol to a film-forming resin composition comprising at least one epoxy resin and at least one nonionic reactive epoxy resin emulsifier, especially at least one nonionic reactive epoxy resin emulsifier derived from a cardanol polyoxyethylene ether, or to an aqueous curing system comprising an epoxy-reactive curing agent can significantly extend pot life of the resulting two-component aqueous epoxy resin paint, for example to up to 24 hours, which was hardly expected prior to the present application.

The details of one or more embodiments of the present application are set forth in the description below. Other features, objects, and advantages of the present application will be apparent from the description, and from the claims.

### Definition

As used herein, “a”, “an”, “the”, “at least one”, and “one or more” are used interchangeably. Thus, for example, a composition that comprises “an” additive can be interpreted to mean that the composition includes “one or more” additives.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the present application, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the term “coating” and “paint film” have the same meaning and are formed by applying and curing a two-component coating composition.

In the context of the present application, the term “two-component coating composition” means a coating composition comprising two or more separately stored components that are mixed together upon applying and which can be dried and cured for an acceptable period to form a coating having desired mechanical properties, such as hardness.

In the context of the present application, the term “non-ionic reactive epoxy resin emulsifier” refers to an adduct formed by the addition of an epoxy resin, such as an epoxy resin having an epoxy equivalent of 400 g/eq to 2500 g/eq, to a non-ionic surfactant. In one embodiment of the present application, the nonionic reactive epoxy resin emulsifier is an adduct formed by the addition of an epoxy resin to a cardanol polyoxyethylene ether.

When used for an “epoxy resin” and/or a “non-ionic reactive epoxy resin emulsifier”, the term “epoxy equivalent” refers to the mass of the relevant material containing 1 mol of epoxy groups. Generally, the lower the epoxy equivalent, the more epoxy groups contained in the relevant material is, and the higher the reactivity is. In an embodiments of the present application, epoxy equivalent of the epoxy resin and the non-ionic reactive epoxy resin is usually provided by suppliers and may be measured according to ASTM D 1652.

As used herein, the term “pot life” refers to the time it takes for the viscosity of the system obtained by mixing all components of the coating composition if necessary with a certain agitation to promote the mixing to reach twice the initial viscosity of the system. Unless otherwise stated, the pot life usually refers to the pot life at room temperature such as from 20 to 25° C.

As used herein, the term “paint” refers to a coating composition that can be applied to a substrate or other coatings and dried, crosslinked, or otherwise hardened to form a non-sticky continuous film having sufficient adhesion to the surface of substrate or other coatings.

The term “comprises”, “comprising”, “contains” and variations thereof do not have a limiting meaning where these terms appear in the description and claims.

The terms “preferred” and “preferably” refer to embodiments of the present application that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present application.

### DETAILED DESCRIPTION

The embodiments of the present application provide a two-component aqueous epoxy resin paint, comprising:
a) a film-forming resin composition, the film-forming resin composition comprising at least one aqueous epoxy resin emulsion, deionized water, and additional additives; and
b) an aqueous curing system comprising an epoxy-reactive curing agent;
wherein the at least one aqueous epoxy resin emulsion comprises at least one epoxy resin, at least one nonionic reactive epoxy resin emulsifier and deionized water, and
wherein the two-component aqueous epoxy resin paint comprises at least one hydroxyl compound, the at least one hydroxyl compound comprising at least one C1-C6 monohydric alcohol, at least one monoalkyl ether of C2-C3 dihydric alcohol, or a combination thereof. Prior to construction, all components described are mixed and then applied.

As described above, the conventional two-component aqueous epoxy resin paint has a pot life of generally 2-4 h, which requires application to be completed within such a period after the paint is formulated, to avoid difficult application or performance degradation at a later stage. In addition, this limited application window requires two-component aqueous epoxy resin paint to be made in small batches, and the paint has to be formulated many times during application. Through extensive study, the inventors of the present application surprisingly discovered that in the formulation of a two-component aqueous epoxy resin paint, adding specific hydroxyl compounds, for example at least one C1-C6 monohydric alcohol and/or at least one monoalkyl ether of C2-C3 dihydric alcohol to a film-forming resin composition comprising at least one epoxy resin and at least one nonionic reactive epoxy resin emulsifier, especially at least one nonionic reactive epoxy resin emulsifier derived from a cardanol polyoxyethylene ether, or to an aqueous curing system comprising an epoxy-reactive curing agent can significantly extend pot life of the resulting two-component aqueous epoxy resin paint, so that the resulting two-component aqueous epoxy resin paint may reach a pot life of 24 hours or longer. In other words, in the formulation of a two-component aqueous epoxy resin paint according to the present application, the combination of a film-forming resin composition comprising at least one nonionic reactive epoxy resin emulsifier, in particular a nonionic reactive epoxy resin emulsifier derived from a cardanol polyoxyethylene ether, with a specific hydroxyl compound, rather than with an arbitrary organic solvent suitable for the formulation of a paint composition can significantly extend the pot life of the resultant two-component aqueous epoxy resin paint, which was hardly expected prior to the present application.

Thus, in embodiments according to the present application, the two-component coating composition comprises at least one hydroxyl compound, the at least one hydroxyl compound comprising at least one C1-C6 monohydric alcohol, at least one monoalkyl ether of C2-C3 dihydric alcohol or a combination thereof. In a preferred embodiment according to the present application, the two-component coating composition comprises at least one hydroxyl compound, the at least one hydroxyl compound comprising at least one C2-C4 monohydric alcohol, at least one C1-C4 monoalkyl ether of C2-C3 dihydric alcohol or a combination thereof.

As an example of a C2-C4 monohydric alcohol, ethanol, n-propanol, isopropanol or combinations thereof may be given. As examples of C1-C4 monoalkyl ether of C2-C3 dihydric alcohol, ethylene glycol monomethyl ether, ethylene glycol monopropyl ether, ethylene glycol monobutyl ether, propylene glycol monomethyl ether, propylene glycol monoethyl ether, propylene glycol monopropyl ether, propylene glycol monobutyl ether or combinations thereof may be given. Monoalkyl ethers of dihydric alcohols usually having a larger molecular structure, such as monoalkyl ethers of butylene glycol, monoalkyl ethers of diethylene glycol, and the like, are less preferred.

The alcohols and alcohol ethers disclosed above are of a source that is well known. As examples of alcohols and alcohol ethers, any commercially available alcohol product and alcohol ether product may be used.

According to embodiments of the present application, the amount of the hydroxyl compounds may be selected as desired. Typically, the amount of the hydroxyl compounds should not be too high to minimize or avoid excessive VOC emissions from the coating composition. Preferably, the hydroxyl compounds may be present in an amount of at most 15% by weight, preferably at most 10% by weight, further preferably at most 9% by weight, relative to the total weight of the two-component aqueous epoxy resin paint. However, the amount of the hydroxyl compounds in the coating composition should not be too low, otherwise it will not serve to extend the pot life of the two-component aqueous epoxy resin paint. Preferably, the hydroxyl compounds may be present in an amount of at least 0.2% by weight, preferably at least 0.3% by weight, further preferably 0.4% by weight or higher, 0.6% by weight or higher, or 1.0% by weight or higher, relative to the total weight of the two-component aqueous epoxy resin paint.

In some embodiments of the present application, the at least one hydroxyl compound is present in an amount in the range of from 2% by weight to 15% by weight, preferably in the range of from 3% by weight to 10% by weight, more preferably in the range of from 3% by weight to 7% by weight, and still more preferably in the range of from 3% by weight to 5% by weight, relative to the total weight of the two-component aqueous epoxy resin paint.

During application, the specific hydroxyl compounds described above may be added to the component A) film-forming resin composition, the component B) aqueous curing system, and/or both, as desired.

### Film-Forming Resin Composition

In the context of the present application, a film-forming resin composition refers to a resin composition constituting the main component of a paint film formed from the two-component aqueous epoxy resin paint of the present application, comprising at least one aqueous epoxy resin emulsion, deionized water and additional additives. In an embodiment according to the present application, the at least one aqueous epoxy resin emulsion comprises at least one epoxy resin, at least one non-ionic reactive epoxy resin emulsifier and deionized water.

According to certain embodiments of the present application, the aqueous epoxy resin emulsion comprises an epoxy resin having an epoxy equivalent of between 200-2000 g/eq. The term “epoxy resin” as used herein refers to a polymer or oligomer containing two or more epoxy groups in one molecule. Preferably, the epoxy resin contains at most four epoxy groups in one molecule. More preferably, the epoxy resin contains two or three epoxy groups in one molecule. The epoxy resin is used for providing a resin component for the aqueous epoxy resin emulsion. In one aspect, the resin component functions as a binder which provides adhesion to a substrate, and holds together other components, such as fillers, of the epoxy resin composition to impart basic cohesive strength to the paint film formed from the epoxy resin paint of the present application. In the other aspect, the resin component has good reactivity with a curing agent, thereby providing a coating having high mechanical strength, in terms of hardness, flexibility, and the like.

According to some embodiments of the present application, the epoxy resin may have an epoxy equivalent varying over a wide range, wherein the epoxy equivalent is the mass of an epoxy resin containing 1 mole of epoxy group. As used herein, the aqueous epoxy resin emulsion comprises an epoxy resin having an epoxy equivalent between 200 and 2000 g/eq, preferably between 200 and 1500 g/eq, more preferably between 200 and 1000 g/eq.

Suitable epoxy resin comprises, for example diglycidyl ether of polyhydric phenol, such as diglycidyl ether of resorcinol, diglycidyl ether of catechol, diglycidyl ether of hydroquinone, diglycidyl ether of bisphenol A, diglycidyl ether of bisphenol F, diglycidyl ether of bisphenol S, diglycidyl ether of tetramethyl bisphenol; diglycidyl ether of polyhydric alcohol, such as diglycidyl ether of aliphatic glycol and diglycidyl ether of polyether glycol, for example diglycidyl ether of C₂₋₂₄ alkylene glycol, diglycidyl ether of poly(ethylene oxide) glycol or diglycidyl ether of poly(propylene oxide) glycol; or polyglycidyl ether of novolack resin, such as polyglycidyl ether of phenol-formaldehyde resin, polyglycidyl ether of alkyl substituted phenol-formaldehyde resin, polyglycidyl ether of phenol-hydroxyl benzaldehyde resin, or polyglycidyl ether of cresol-hydroxyl benzaldehyde resin; or the combination thereof.

According to some embodiments of the present application, the epoxy resin is a diglycidyl ether of polyhydric phenol, especially preferably having the structure of formula (II):

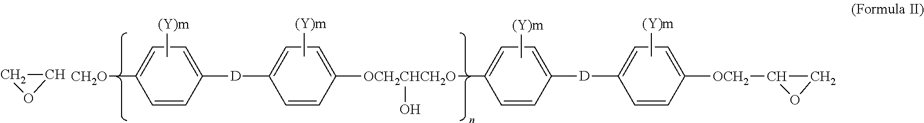

wherein
D each represents —S—, —S—S—, —SO—, —SO₂—, —CO₂—, —CO—, —O— or C₁ to C₁₀ alkylene, preferably C₁ to C₅ alkylene, more preferably C₁ to C₃ alkylene, such as —CH₂— or —C(CH₃)₂—,
Y each independently represents halogen, such as F, Cl, Br, or I, or optionally substituted monovalent C₁ to C₁₀ hydrocarbon group, such as optionally substituted methyl, ethyl, vinyl, propyl, allyl or butyl;
m each independently represents 0, 1, 2, 3 or 4, and
n represents an integer from 0 to 4, such as 0, 1, 2, 3 or 4.

More preferably, the epoxy resin is bisphenol A epoxy resin, bisphenol S epoxy resin or bisphenol F epoxy resin having the structure of formula (II) in which D represents —C(CH₃)₂—, —SO₂— or —CH₂-respectively, m represents 0, and n represents an integer from 0 to 4.

Most preferably, the epoxy resin is bisphenol A epoxy resin having the structure of formula (II) in which D represents —C(CH₃)₂—, m represents 0, and n represents an integer from 0 to 4.

The epoxy resin as disclosed herein may be prepared by the epichlorohydrin technology which is well-known by those skilled in the art, for example. Alternatively, as an example of epoxy resin, any suitable commercial product may be used, for example E55, E51, E44, or E20 available from Kaiping Resin Company, Shanghai, China.

In some embodiments according to the present application, the epoxy resin may be in liquid form. In some other embodiments according to the present application, the epoxy resin may be in solid form. In the presently preferred embodiment of the present application, the epoxy resin is in solid form.

In some embodiments of the present application, the at least one epoxy resin is present in an amount in the range of 10 wt. % to 65 wt. %, preferably in the range of 15 wt. % to 65 wt. %, more preferably in the range of 20 wt. % to 65 wt. %, still more preferably in the range of 25 wt. % to 60 wt. %, and even more preferably in the range of 35% by weight to 52% by weight, relative to the total weight of the aqueous epoxy resin emulsion.

In embodiments according to the present application, in addition to the epoxy resin described above, the aqueous epoxy resin emulsion further comprises at least one non-ionic reactive epoxy resin emulsifier and deionized water for its formation.

As described above, the non-ionic reactive epoxy resin emulsifier is an adduct formed by the addition of an epoxy resin, for example an epoxy resin having an epoxy equivalent in the range of 400 g/eq to 2,500 g/eq, with a non-ionic surfactant, which not only can act as an emulsifier for the epoxy resin and but also has an appropriate reactivity to react with a curing agent, thereby reducing, or even avoiding, the risk of migration from the coating.

In an embodiment according to the present application, the non-ionic reactive epoxy resin emulsifier is derived from a cardanol polyoxyethylene ether. As an exemplary illustration, the cardanol polyoxyethylene ether has a structure shown in Formula (I) below:

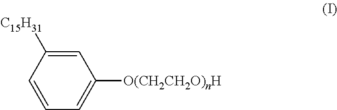

wherein n is in the range of 10-60.

It was found by the inventors of the present application that the above-described cardanol polyoxyethylene ether for forming the nonionic reactive epoxy resin emulsifier has a hydrophilic segment comprising 10-60 EO/PO units, and has a hydrophobic segment having a large conjugate group that increases intermolecular interactions. It is based on the above reasons that the emulsifier is capable of emulsifying epoxy resins well, and even solid epoxy resins well. Thus, the aqueous epoxy resin emulsion formulated therefrom is characterized by a suitable particle size and a uniform particle size distribution.

In an embodiment according to the present application, the non-ionic reactive epoxy resin emulsifier has an epoxy equivalent in the range of 10,000 g/eq to 40,000 g/eq, as determined according to ASTM D1652.

In an embodiment according to the present application, the non-ionic reactive epoxy resin emulsifier is in solid form.

The non-ionic reactive epoxy resin emulsifier may be prepared empirically by one skilled in the art. Alternatively, the non-ionic reactive epoxy resin emulsifier may be any suitable commercially available product, such as a non-ionic reactive epoxy resin emulsifier of GF-40 from Jiangsu Hai'an Petrochemical.

In an embodiment according to the present application, the at least one non-ionic reactive epoxy resin emulsifier is present in an amount in the range of 3% by weight to 20% by weight relative to the total weight of the aqueous epoxy resin emulsion.

As an exemplary illustration, the above-described aqueous epoxy resin emulsion may be formulated using the above-described epoxy resin, nonionic reactive epoxy resin emulsifier, and deionized water by any method suitable for formulating aqueous emulsions which is known to those skilled in the art. In a preferred embodiment according to the present application, the above-described aqueous epoxy resin emulsion is formulated as follows. Specifically, the at least one epoxy resin and the at least one non-ionic reactive epoxy resin emulsifier are melted and mixed at a stirring speed of 1400-1600 rpm to which deionized water is added slowly until a reversed phase is reached while stopping the addition of deionized water and dispersing it at a stirring speed of 1800-2000 rpm; and then deionized water is further added to form the aqueous epoxy emulsion. It was found by the inventors of the present application that the aqueous epoxy resin emulsion formed by the method described above has particularly excellent stability, including, but not limited to, high temperature stability and solvent stability. For example, the aqueous epoxy resin emulsion formulated using the method described above can be stored at a high temperature of 50° C. for 1 month or longer without demulsification and/or can be stored in the presence of a high concentration of a wide range of organic solvents including 30% dipropylene glycol butyl ether (DPnB), dipropylene glycol methyl ether (DPM), propylene glycol propyl ether (PnP), butyl ethylene glycol butyl ether (BCS), Texanol, and ethanol without demulsification, which was hardly expected prior to the present application.

In an embodiment according to the present application, the aqueous epoxy emulsion has a solids content of 38-75% by weight, preferably has a solids content of 40-70% by weight, more preferably has a solids content of 45-65% by weight.

In an embodiment according to the present application, the aqueous epoxy emulsion has an epoxy equivalent of 900-1100 g/eq.

In an embodiment according to the present application, the aqueous epoxy resin emulsion comprises particles with a particle size of less than 30 micrometers.

Preferably, the aqueous epoxy resin emulsion is present in an amount of from about 10% by weight to about 65% by weight, preferably from about 15% by weight to about 65% by weight, more preferably from about 20% by weight to about 65% by weight, and still more preferably from about 25% by weight to about 65% by weight, by weight, relative to the total weight of the film-forming resin composition.

Although the mechanism was not known, it was surprisingly found by the inventors of the present application that in the formulation of the two-component aqueous epoxy resin paint, when the aqueous epoxy resin emulsion formulated from the specific nonionic reactive epoxy resin emulsifier described above was combined with the specific hydroxyl compounds described above, the resultant two-component aqueous epoxy resin paint has a significantly extended pot life, that could be even up to 24 hours.

The film-forming resin composition according to the present application may further comprise pigment/fillers, aqueous media and/or additional additives.

In embodiments of the present application, “pigment filler” is a generic term for pigments and fillers.

According to embodiments of the present application, the term “filler” as used herein refers to any volume extender suitable for the two-component aqueous epoxy resin paint, which may be inorganic, for example, in the form of particles. There is no particular limitation on the shape of particles, and they can have any appropriate shape. The average particle size of the filler can vary within a wide range, for example, within a range of about 10 nanometers to about 50 microns. Some fillers, in addition to functioning as volume extenders, also impart one or more desired properties to the composition and/or the coating formed from the composition. For example, some fillers can improve chemical and/or physical properties, especially mechanical properties of the coating obtained from the composition. In this case, this filler is also called “reinforcing filler”. Suitable fillers may include, for example, silicates, sulfates, carbonates, silica. Suitable exemplary fillers include, for example, china clay, wollastonite, barite, calcium carbonate, diatomaceous earth, talc, barium sulfate, magnesium aluminum silicate, silicon dioxide, and any combination thereof.

According to embodiments of the present application, the term “pigment” refers to an agent used to provide a color, tone, or hue to the two-component aqueous epoxy resin paint. Suitable pigments may include iron oxide, carbon black, lead oxide, lead carbonate, zinc oxide, titanium oxide, deep sea blue, chrome green, or chromium oxide, or combinations thereof. As a special pigment, “rust inhibiting pigments” further have the effect of preventing rusting of metal substrates, including but not limited to zinc phosphate, zinc molybdenum phosphate and aluminum tripolyphosphate. As examples of rust inhibiting pigments, any suitable commercially available product may be used, such as those commercially available from HEUCOPHOS CAPP, HEUCOPHOS SAPP, HEUCOPHOS ZPA, and the like. In a preferred embodiment of the present application, the film-forming resin composition comprises titanium oxide, carbon black, a rust inhibiting pigment, and combinations thereof.

According to certain embodiments of the present application, the total amount of pigment filler can vary within a wide range, for example, the total amount thereof is in the range of about 5% to about 65% by weight, preferably in the range of about 10% by weight to 60% by weight, more preferably in the range of about 10% by weight to 55% by weight relative to the total weight of the film-forming resin composition.

According to embodiments of the present application, the film-forming resin composition may comprise any suitable aqueous medium. Suitable aqueous media include water-soluble organic solvents, water and mixtures thereof.

According to certain embodiments of the present application, the film-forming resin compositions may further comprise additional additives commonly used in aqueous epoxy resin paints that do not adversely affect the coating compositions or the cured coatings obtained therefrom. Suitable additives include, for example, those agents that will improve processability or manufacturability of the composition, enhance aesthetics of the composition, or improve a particular functional property or characteristic (such as adhesion to the substrate) of the coating composition or the cured composition obtained therefrom. Additives that may be included are, for example, dispersants, leveling agents, film forming aids, co-solvents, biocides, mold inhibitors, chain extenders, lubricants, biocides, plasticizers, defoamers, color spreaders, waxes, antioxidants, adhesion promoters, UV stabilizers, or combinations thereof. The amount of each optional ingredient is sufficient to serve its intended purpose, but preferably such an amount will not adversely affect the coating composition or the cured coating obtained therefrom. In preferred embodiments of the present application, suitable additional additives include dispersants, leveling agents, film forming aids, co-solvents, or any combination thereof.

The content of each optional component is sufficient to achieve its intended purpose, but preferably, such content does not adversely affect the film-forming resin composition or the coating obtained therefrom. According to certain embodiments of the present application, the total amount of additional additives is in the range of about 0% by weight to about 20% by weight, preferably about 0% by weight to about 10% by weight relative to the total weight of the film-forming resin composition.

The preparation of the film-forming resin composition of the present application may be achieved by any suitable mixing method known to those of ordinary skill in the art. For example, the film-forming resin composition can be made as follows: pre-mixing the pigment filler and aqueous medium and then grinding and dispersing them with a grinder, thereby obtaining a homogeneous system, and then adding the system with the aqueous epoxy resin emulsion, the remaining pigment filler, and the additional additives (if any) to a container, and then stirring the resultant mixture uniformly.

### Aqueous Curing System

According to some embodiments of the present application, the aqueous curing system used for the two-component aqueous epoxy resin paint comprises an epoxy reactive curing agent selected from an aliphatic polyamine, a fatty amine adduct, an amidoamine, an amino polyamide resin, a cycloaliphatic amine, an aromatic amine, an aromatic-aliphatic amine, a Mannich base, a ketimine, and a dicyandiamide or combinations thereof.

According to some embodiments of the present application, the curing agent is well-known in the art, for example it is disclosed in “Paint Technology” edited by Liu Dengliang, fourth edition, 2010, No. 275-280, the disclosure of which is incorporated herein by reference.

According to certain embodiments of the present application, the aqueous curing system comprises, based on the total weight of the curing system, 50-70% by weight of an epoxy reactive curing agent and 30-50% by weight of a solvent, the solvent being water or a solvent miscible with water.

According to some embodiments of the present application, the weight ratio of the epoxy reactive curing agent to the film-forming resin composition may be varied in the range of 8:100 to 20:100. Generally, when the weight ratio of the epoxy reactive curing agent to the film-forming resin composition is less than 8:100, the curing performance of the resulting coating is poor. Generally, when the weight ratio of the epoxy reactive curing agent to the film-forming resin composition is greater than 20:100, the operating performance of the resulting epoxy resin paint and/or the mechanical properties of the resulting coating may decrease. According to actual needs, an additional inert diluent that will not affect reactivity of the epoxy reactive curing agent and the film-forming resin composition can be added during the preparation of the above curing agent and the film-forming resin composition, so as to reduce the components' viscosity. Therefore, the weight ratio of the curing agent to the film-forming resin composition is not limited to the above range, and can be adjusted according to actual needs.

According to some embodiments of the present application, the two-component aqueous epoxy resin paint can be prepared as follows. The epoxy reactive curing agent is mixed with a suitable solvent to obtain an aqueous curing system and before application, the film-forming resin composition and the aqueous curing system are simply mixed in a mixing device in a predetermined weight ratio. According to embodiments of the present application, the film-forming resin composition is mixed with the aqueous curing system, and the resulting mixture exhibits a pot life of 24 hours or longer at 25° C. The mixed epoxy paint can be applied using various methods familiar to those skilled in the art, including spraying (for example, air-assisted, airless or electrostatic spraying), brushing, roller coating, overflow coating, and dipping. In one embodiment of the present application, the mixed epoxy resin paint is applied by spraying. Epoxy resin paint can be applied as to various wet film thicknesses. In an embodiment of the present application, the epoxy resin paint is applied in such a wet film thickness that it may preferably provide a dry film thickness of about 45 to about 200 μm, and more preferably about 45 to about 100 μm. The applied coating can be cured by air-drying or by using various drying devices (for example, an oven) familiar to those skilled in the art to accelerate the curing. The preferred heating temperature for curing epoxy resin paint is from about 60° C. to about 100° C., and more preferably from about 60° C. to about 80° C., and the preferred heating time is from at least three minutes to less than 60 minutes, to less than 45 minutes, or to less than 40 minutes. The heating time will tend to decrease with increasing temperature or increasing airflow.

In an embodiment according to the present application, the two-component aqueous epoxy resin paint, and the paint film formed therefrom, display desired coating and paint film properties, for example properties comparable to or superior to those of conventional aqueous epoxy resin paints when tested by one or more of the following tests including, but not limited to, abrasive resistance, solvent impact resistance, fineness, drying speed, workability, acid and alkali resistance, salt spray resistance, flexibility and hardness.

### Article

In another aspect, the present application provides an article, comprising a substrate having at least one major surface; and a coating formed by the two-component aqueous epoxy resin paint of the present application directly or indirectly applied to the major surface.

As a substrate for use in the manufacture of the article of the present application, any suitable material for the substrate known in the art may be used. By way of exemplary illustration, the substrate material is selected from metal, wood, wood composite, paper, plastic, fabric, ceramic, cementitious material or any combination thereof.

In one embodiment of the present application, the substrate is preferably a metal substrate. As an example, the metal substrate is selected from steel, iron, aluminum, zinc and their alloys.

According to the present application, the article can be prepared, for example, by the following steps: (1) providing a polished metal substrate; (2) using a coating and curing process to sequentially coat and form one or more epoxy resin based primers of the invention on the metal substrate to provide corrosion resistance for the metal substrate.

According to the present application, the metal article thus obtained can be further treated with an additional primer and anticorrosive topcoat, and can be used for the following terminal applications, including but not limited to refrigerated containers and unrefrigerated shipping containers (e.g., dry cargo containers) from suppliers or manufacturers including China International Marine Containers (CIMC), Graaff Transportsysteme Gmbh, Maersk Line and others that will be familiar to persons having ordinary skill in the art, chassis, trailers including semitrailers, rail cars, truck bodies, ships, bridges, building skeletons, and other prefabricated or site-fabricated metal articles needing temporary indoor or outdoor corrosion inhibition during fabrication. Additional uses include metal angles, channels, beams (e.g., I-beams), pipes, tubes, plates and other components that may be welded into these and other metal articles.

As noted above, the inventors of the present application were surprised to find that in the formulation of a two-component aqueous epoxy resin paint, adding specific hydroxyl compounds, for example at least one C1-C6 monohydric alcohol and/or at least one monoalkyl ether of C2-C3 dihydric alcohol to a film-forming resin composition comprising at least one epoxy resin and at least one nonionic reactive epoxy resin emulsifier, especially at least one nonionic reactive epoxy resin emulsifier derived from a cardanol polyoxyethylene ether, or to an aqueous curing system comprising an epoxy-reactive curing agent can significantly extend pot life of the resulting two-component aqueous epoxy resin paint, for example to up to 24 hours.

Therefore, the present application in another aspect further provides a novel application, i.e. use of at least one hydroxyl compound for extending pot life of a two-component aqueous epoxy resin paint, wherein the at least one hydroxyl compound comprises at least one C1-C6 monohydric alcohol, at least one monoalkyl ether of C2-C3 dihydric alcohol, or a combination thereof and the two-component aqueous epoxy resin paint comprises at least one epoxy resin and at least one nonionic reactive epoxy resin emulsifier.

### EXAMPLES

The present application is more particularly described in the following examples that are intended as illustrations only, since numerous modifications and variations within the scope of the present application will be apparent to those skilled in the art. Unless otherwise noted, all parts, percentages, and ratios reported in the following examples are on a weight basis, and all reagents used in the examples are commercially available and used directly without further treatment.

### Test Methods

Pencil Hardness: was determined using a pencil hardness tester in accordance with ASTM D3363.

Salt Spray Resistance: was tested using a salt spray box according to ASTM B 117.

Water Resistance and Acid and Alkali Resistance: was tested according to HG/T 4566-2013.

Pot Life: was determined as follows. The components of the coating composition were mixed at room temperature and the initial viscosity of the coating composition was tested using an Iwata No. 2 cup. The pot life of the coating composition was defined as the time it takes for the viscosity of the system to rise to twice its initial viscosity.

Raw material:
Epoxy resin: commercially purchased epoxy resin NPES 901 from South Asia, epoxy equivalent 450-500;
Nonionic reactive epoxy resin emulsifier: commercially purchased from Jiangsu Hai'an Petrochemical's nonionic reactive epoxy resin emulsifier GF-40 derived from cardanol polyoxyethylene ether, which is a light yellow solid, with an epoxy equivalent of 10,000 to 40,000, and a pH of 5-8;
Control epoxy resin emulsion: Hexion EPIKOTE 6529-WH-57 commercially purchased from Hansen, U.S.A., which is emulsified with a conventional epoxy resin emulsifier. NP8836, commercially purchased from Hengshengyuan (Shenzhen) New Material Technology Co., Ltd. can be regarded as an example of the conventional epoxy resin emulsifier.
Solvent/Diluent: butyl acetate, butanone, dipropylene glycol butyl ether, ethanol, isopropanol, 150 #, propylene glycol methyl ether acetate, ethylene glycol butyl ether, general industrial products;
Pigment and filler: barium sulfate, antirust filler, titanium dioxide, general industrial products;
Additional additives, general industrial products.

### Aqueous Epoxy Resin Emulsion

35-52% by weight of epoxy resin and 3-20% by weight of nonionic reactive epoxy resin emulsifier were melted and mixed at a stirring speed of 1400-1600 rpm to which deionized water and propylene glycol methyl ether co-solvent were slowly added until it reaches a reversed phase while stopping the addition of deionized water and dispersing it at a stirring speed of 1800-2000 rpm; and then to the resulting mixture deionized water was further added, thereby forming said aqueous epoxy emulsion, wherein the propylene glycol methyl ether is added in an amount of 3-10% by weight and the deionized water is added in an amount of 30-60% by weight.

For purposes of comparison, a control emulsion similar to the above-described aqueous epoxy resin emulsion was also prepared.

### Two-Component Aqueous Epoxy Resin Paint

As shown in Table 1 below, a homogeneous system was obtained by pre-mixing a co-solvent with a pigment filler and deionized water and then grinding and dispersing the system with a mill; the system was then mixed with the above homemade aqueous epoxy resin emulsion, water, the remaining pigment filler, and additional additives to obtain a film-forming resin composition as component A. The curing agent was then mixed with the corresponding solvent to obtain an aqueous curing system as a B component. The resulting A-component is then mixed with the B-component and additional solvents/diluents to form the two-component aqueous epoxy resin paint of Examples 1-3 and Comparative examples 1-5 and Comparative Example A, wherein Examples 1-3 comprise ethanol, isopropanol, and ethylene glycol butanol, respectively, and Comparative examples 1-5 comprise butyl acetate, butanone, dipropylene glycol butyl ether, 150 #and propylene glycol methyl ether acetate, respectively, and Comparative Example A does not contain any additional added solvents/diluents; Example B used a control epoxy resin emulsion.

Then, the mixtures obtained from the above embodiments and the counterparts were tested at different moments for their viscosities, respectively, to determine their pot life. In addition, the hardness, water resistance, acid and alkali resistance, and salt spray resistance of the two-component aqueous epoxy resin paint according to the above examples and the comparative examples were determined. The results are summarized in Table 1.

TABLE 1
shows the composition of two-component aqueous epoxy resin paints and their viscosity, as well as the properties of the coatings
obtained from them.

| | | Ex- | Ex- | Ex- | Com- | Com- | Com- | Com- | Com- | Com- | Com- |
|---|---|---|---|---|---|---|---|---|---|---|---|
| | | am | am | am | parative | parative | parative | parative | parative | parative | parative |
| | Ingredients | ple 1 | ple 2 | ple 3 | Example 1 | Example 2 | Example 3 | Example 4 | Example 5 | Example A | Example B |
| Component | Aqueous epoxy resin | 45 | 45 | 45 | 45 | 45 | 45 | 45 | 45 | 45 | [symbol] |
| A | emulsion | | | | | | | | | | |
| | Deionized water | 15 | 15 | 15 | 15 | 15 | 15 | 15 | 15 | 15 | 15 |
| | Barium sulfate | 6 | 6 | 6 | 6 | 6 | 6 | 6 | 6 | 6 | 6 |
| | Carbon Black | 1 | 1 | 1 | 1 | 1 | 1 | 1 | 1 | 1 | 1 |
| | Antirust pigment | 7 | 7 | 7 | 7 | 7 | 7 | 7 | 7 | 7 | 7 |
| | Titanium dioxide | 10 | 10 | 10 | 10 | 10 | 10 | 10 | 10 | 10 | 10 |
| | Co-solvents | 10 | 10 | 10 | 10 | 10 | 10 | 10 | 10 | 10 | 10 |
| | Additional additives | 6 | 6 | 6 | 6 | 6 | 6 | 6 | 6 | 6 | 6 |
| Component | Epoxy reactive curing | 20 | 20 | 20 | 20 | 20 | 20 | 20 | 20 | 20 | 20 |
| B | agents | | | | | | | | | | |
| | Aqueous media | 10 | 10 | 10 | 10 | 10 | 10 | 10 | 10 | 10 | 10 |
| Solvents/ | Ethanol | 10 | — | — | — | — | — | — | — | — | 10 |
| diluents | Isopropyl alcohol | — | 10 | — | — | — | — | — | — | — | — |
| | Ethylene glycol butyl | — | — | 10 | — | — | — | — | — | — | — |
| | ether | | | | | | | | | | |
| | Butyl acetate | — | — | — | 10 | — | — | — | — | — | — |
| | Butanone | — | — | — | — | 10 | — | — | — | — | — |
| | Dipropylene glycol | — | — | — | — | — | 10 | — | — | — | — |
| | butyl ether | | | | | | | | | | |
| | 150# | — | — | — | — | — | — | 10 | — | — | — |
| | Propylene glycol | — | — | — | — | — | — | — | 10 | — | — |
| | methyl ether acetate | | | | | | | | | | |
| Viscosity | 0 hours after mixing | 126 | 144 | 234 | 611.9 | 269.9 | 491.9 | 743.8 | 305.9 | 247 | 315 |
| (mPa · s) | 2 hours after mixing | 132 | 174 | 353.9 | 911.8 | 348 | 755.8 | 905.8 | 443.9 | 285 | 635 |
| | 19 hours after mixing | 180 | 222 | 419.9 | 1644 | 527.9 | 1128 | 1320 | 767.8 | 869 | [symbol] |
| | 24 hours after mixing | 204 | 281 | 425.9 | 1734 | 831.8 | 1128 | 1446 | 863.8 | 1096 | [symbol] |
| Coating properties | | | | | | | | | | | |
| Test results | Pot life | 24 h | 24 h | 24 h | 4 h | 4 h | 2 h | 4 h | 4 h | 4 h | [symbol] |
| (Construction | hardness | 3H | 3H | 3H | 3H | 3H | 3H | 3H | 3H | 3H | [symbol] |
| time selected | Water resistance@14 d | pass | pass | pass | pass | pass | pass | pass | pass | pass | [symbol] |
| as the longest | Acid resistance (0.1M) | pass | pass | pass | pass | pass | pass | pass | pass | pass | [symbol] |
| time within | Base resistance (0.1M) | pass | pass | pass | pass | pass | pass | pass | pass | pass | [symbol] |
| pot life) | Sat spray @ 500 h | pass | pass | pass | pass | pass | pass | pass | — | — | — |

[symbol]

indicates data missing or illegible when filed

As can be seen from the comparison results of Examples 1-3 and Comparative Examples 1-5 above, small molecule alcohols and partially small molecule mono-modified alcohol ether solvents are preferred, with ethanol and isopropanol being optimal in terms of both lowering viscosity of the system and extending pot life of the system. In contrast, other diluents commonly used in the field of coatings, including acetates, ketones, multi-diol monoethers and alcohol ether esters, and aromatics, when added to the two-component aqueous epoxy resin paint according to the present application, do not extend pot life of the system, and are even less effective in reducing viscosity of the system.

Furthermore, as can be seen from the comparison results between Examples 1-3 and Comparative Example A above, the addition of small molecule alcohols and partially small molecule mono-modified alcohol ether solvents such as ethanol, isopropanol and glycol butyl ether significantly extends pot life of the system and the resulting coatings exhibit performances comparable to, or even better than, that of the system without any additional added solvents and diluents.

Furthermore, as can be seen from the comparative results of Examples 1-3 and Comparative Example B above, the combination of an aqueous epoxy resin emulsion comprising a specific nonionic reactive epoxy resin emulsifier with a specific hydroxyl compound significantly exhibits pot life of the resulting two-component aqueous epoxy resin paint.

While the present application has been described with respect to a number of embodiments and examples, those skilled in the art, having benefit of this invention, will appreciate that other embodiments can be devised which do not depart from the scope and spirit of the present application as disclosed herein.

What is claimed is:

1. A two-component aqueous epoxy resin paint comprising:
a) a film-forming resin composition, the film-forming resin composition comprising at least one aqueous epoxy resin emulsion, deionized water, and additional additives; and
b) an aqueous curing system comprising an epoxy-reactive curing agent;
wherein the at least one aqueous epoxy resin emulsion comprises at least one epoxy resin, at least one nonionic reactive epoxy resin emulsifier and deionized water, and
wherein the two-component aqueous epoxy resin paint comprises at least one hydroxyl compound, the at least one hydroxyl compound comprising at least one C1-C6 monohydric alcohol, at least one monoalkyl ether of C2-C3 dihydric alcohol, or a combination thereof.

2. The two-component aqueous epoxy resin paint as claimed in claim 1, wherein the at least one hydroxyl compound comprises at least one C2-C4 monohydric alcohol, at least one C1-C4 monoalkyl ether of C2-C3 dihydric alcohol, or a combination thereof, preferably ethanol, n-propanol, isopropanol, ethylene glycol monomethyl ether, ethylene glycol monopropyl ether, ethylene glycol monobutyl ether, propylene glycol monomethyl ether, propylene glycol monoethyl ether, propylene glycol monopropyl ether, propylene glycol monobutyl ether, or a combination thereof.

3. The two-component aqueous epoxy resin paint as claimed in claim 1, wherein the at least one hydroxyl compound is present in an amount in the range of 2 to 15% by weight, preferably in the range of 3 to 7% by weight, relative to the total weight of the two-component aqueous epoxy resin paint.

4. The two-component aqueous epoxy resin paint as claimed in claim 1, wherein the at least one nonionic reactive epoxy resin emulsifier is in solid form and derived from a cardanol polyoxyethylene ether.

5. The two-component aqueous epoxy resin paint as claimed in claim 4, wherein the cardanol polyoxyethylene ether has a structure shown in Formula (I): 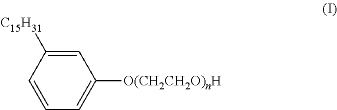
wherein n is in the range of 10-60.

6. The two-component aqueous epoxy resin paint as claimed in claim 4, wherein the at least one nonionic reactive epoxy resin emulsifier is present in amount in the range of 3% to 20% by weight relative to the total weight of the aqueous epoxy resin emulsion, and has an epoxy equivalent in the range of 10,000 g/eq to 40,000 g/eq, as determined according to ASTM D1652.

7. (canceled)

8. (canceled)

9. The two-component aqueous epoxy resin paint as claimed in claim 1, wherein the at least one epoxy resin is present in solid form, in an amount in the range of 10% to 65% by weight relative to the total weight of the aqueous epoxy resin emulsion, and has an epoxy equivalent in the range of from 200 g/eq to 2000 g/eq.

10. (canceled)

11. The two-component aqueous epoxy resin paint as claimed in claim 1, wherein the at least one epoxy resin is a diglycidyl ether of polyhydric phenol of formula (II): 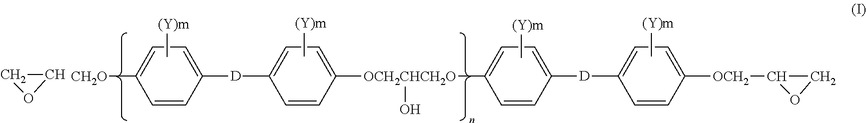
wherein
D each represents —S—, —S—S—, —SO—, —SO₂—, —CO₂—, —CO—, —O—, divalent C₁-C₁₀ alkylene,
Y each independently represents halogen or optionally substituted monovalent C₁ to C₁₀ hydrocarbon group,
m each independently represents 0, 1, 2, 3 or 4, and
n represents an integer from 0 to 4.

12. (canceled)

13. (canceled)

14. The two-component aqueous epoxy resin paint as claimed in claim 1, wherein the at least one aqueous epoxy resin emulsion is formed by: melting and mixing the at least one epoxy resin and the at least one nonionic reactive epoxy resin emulsifier at a stirring speed of 1400-1600 rpm; slowly adding deionized water until a reversed phase is reached while stopping the addition of deionized water and dispersing it at a stirring speed of 1800-2000 rpm; and then adding further deionized water, thereby forming the aqueous epoxy resin emulsion.

15. The two-component aqueous epoxy resin paint as claimed in claim 14, wherein the at least one aqueous epoxy resin emulsion has a solids content of 38-75% by weight.

16. The two-component aqueous epoxy resin paint as claimed in claim 1, wherein relative to the total weight of the film-forming resin composition,
10-65% by weight of the at least one aqueous epoxy resin emulsion
5-20% by weight of deionized water; and
0-55% by weight of additional additives.

17. The two-component aqueous epoxy resin paint as claimed in claim 1, wherein the epoxy-reactive curing agent comprises an aliphatic polyamine, a fatty amine adduct, an amidoamine, an amino polyamide resin, a cycloaliphatic amine, an aromatic amine, an aromatic-aliphatic amine, a Mannich base, a ketimine, and a dicyandiamide or combinations thereof.

18. The two-component aqueous epoxy resin paint as claimed in claim 1, wherein the film-forming resin composition is mixed with the aqueous curing system, the resulting mixture exhibits a pot life of 24 hours or longer at 25° C.

19. An article comprising
a substrate having at least one major surface; and
a coating applied directly or indirectly to at least part of the major surface of the substrate,
wherein the coating is formed by the two-component aqueous epoxy resin paint as claimed in claim 1.

20. The article as claimed in claim 19, wherein the substrate is selected from metal, wood, wood composite, paper, plastic, fabric, ceramic, cementitious material or any combination thereof.

21. (canceled)
